(19) United States
(12) Patent Application Publication
(10) Pub. No.: US 2005/0010624 A1
(43) Pub. Date: Jan. 13, 2005

(54) Method and system for making secure a pseudo-random generator

(76) Inventor: Jean-Luc Stehle, Paris (FR)

Correspondence Address: RATNERPRESTIA, P O BOX 980, VALLEY FORGE, PA, 19482-0980, US

(21) Appl. No.: 10/495,381

(22) PCT Filed: Oct. 24, 2002
(86) PCT No.: PCT/FR02/03652

(30) Foreign Application Priority Data
Nov. 15, 2001 (FR) 01/14785

(51) Int. Cl. G06F 1/02

(52) U.S. Cl. 708/250

(57) ABSTRACT

The invention pertains to a method for making secure a generator generating pseudo-random numbers. The generator is characterized by its internal status. The generator includes: a first storage zone containing status bits, representing the internal status of the generator; a computing unit performing arithmetic operations on the status bits to produce the pseudo-random numbers and to modify the status bits; a second storage zone containing the pseudo-random numbers; a single output for reading the pseudo-random numbers contained in the second storage zone. The method according to the invention includes the step of irreversibly and unconditionally inhibiting, in particular via logical and/or mechanical and/or electronic means, the reading and the writing of the status bits from outside the generator, including via the single output.

METHOD AND SYSTEM FOR MAKING SECURE A PSEUDO-RANDOM GENERATOR

Various applications require the use of numbers drawn at random, hereinafter called random numbers. These random numbers are used in the applications linked with computer security, among others. They are used, in particular, to generate encryption keys instantly, for example, in the Diffie Hellman diagram used in the IPSEC protocol.

All security of the transmissions using such protocols is based on the quality of the random number generator. A random number generator provides strings of bytes that must check a plurality of characteristics. First of all, these byte strings must be statistically random: All the bytes drawn must be equally probable. This means that, on average, there must be as many of 1 as of 2, as of 3, etc., and it must be the same for all pairs of bytes, for all byte triplets, for byte quadruplets, and so forth. More generally, such a string of random bytes must have certain mathematical and statistical properties, which are well known and are described, e.g., in the work of Donald Knuth, The Art of Computer Programming, volume 2: Seminumerical Algorithms, third edition, pages 1 to 193, and, in particular, pages 149 to 183. Apart from these mathematical and statistical properties, the random numbers must be unpredictable in practice. Among other things, the knowledge of the numbers drawn beforehand must not provide any information to a possible pirate, enabling him to guess that one sequence might have greater chances of being drawn than another.

Two large series of random generators are distinguished.

The first series groups together the physical generators. These are based on a physical phenomenon considered to be random. This phenomenon may be, e.g., the background noise of an electronic circuit, the analysis of traffic on a computer network or the result of various computations or hash algorithms, among others, on the content of the random access memory of a computer. The physical generators may be used to generate encryption keys instantly, but they are not reproducible and, in particular, they cannot be used directly to generate an encryption mask.

Moreover, the use of physical generators based on a physical phenomenon considered to be perfectly random may pose some practical problems. The collection of the background noise from an electronic circuit element requires an expensive and cumbersome electronic device to amplify this background noise and to be used to construct bytes checking the required statistical properties. The analysis of the traffic of a computer network is capable of introducing security faults insofar as a pirate might analyze the same traffic, which would enable him to have data about the encryption keys. The same is true if hash algorithms applied to the content of certain computer memories are used, because if a pirate can access these memories, he may deduce the same random numbers from them, thus harming the security of the system.

The second series groups together the generators that are known under the name of pseudo-random generators. These are based on a mathematical algorithm executed on computer equipment and can be produced either purely by software, or on a specific coprocessor. In the mathematical meaning of the term, a pseudo-random generator is a finite, entirely deterministic automaton. For this reason, the numbers generated by a pseudo-random generator are often called pseudo-random numbers. The sequence of the pseudo-random numbers generated depends on the status of the automaton, which is represented in practice by a certain number of bits, hereinafter called the status bits of the pseudo-random generator. With each drawing of a pseudo-random number, the pseudo-random generator reads the value of its status bits, and performs, from these values, computations, the results of which will make it possible, on the one hand, to provide the pseudo-random number sought and, on the other hand, to provide new values of the status bits, which will replace the old values of these status bits. The pseudo-random generator shall then be ready for the next drawing.

We are only interested in the pseudo-random generators below.

The use of pseudo-random generators poses various security problems. In fact, information, even partial information, about the status bits of the pseudo-random generator makes it possible to predict that, among the sequences of pseudo-random numbers that will be drawn, certain sequences shall be more probable than others, and this information may also make it possible to know these more probable sequences. Thus, such information might provide a possible pirate with ammunition to attack the computer system. If the status bits are entirely known, it is possible to predict all of the pseudo-random numbers which will subsequently be drawn, with certainty, which makes any use of this pseudo-random generator for applications aiming to make a computer system secure illusive.

In many pseudo-random generators, it is possible, starting from the history of the previously performed draws, to return to the internal status of the generator and therefore to determine the value of the status bits. The results of all of the future draws may then be determined with certainty. Even if the history only provides partial information, this will make it possible to determine that certain configurations of the status bits are more probable than others, and to compute those, and therefore to predict that certain sequences of pseudo-random numbers shall be more probable than others. Of course, such generators must never be used for computer security applications.

Other pseudo-random generators are based on more sophisticated mathematical algorithms, which do not make it possible, starting from the history of past draws, to return to the internal status of the pseudo-random generator. Nevertheless, others types of attacks are possible.

One possible attack consists of reading the internal status of the pseudo-random generator by reading the storage zone that contains it, or, writing a value specified by the attacker in this storage zone, which leads to the same result. This is possible in various ways, and in particular, by means of viruses or Trojan horses infecting a work station connected to a computer network.

Another attack is the attack by reinitialization. When a computer system is switched on, the random access memory is generally in a given status (all the bits are 0 or all the bits are 1), and the internal status of the pseudo-random generator may thus be known. If an attacker can bring about a brief power failure, he may therefore know the internal status of the pseudo-random generator at the time of the switching back on and it is then possible for him to predict all the future internal status and therefore all the pseudo-random numbers that will be generated.

Another problem linked with the use of pseudo-random generators arises from the fact that they are, in general, implemented by software. When an application does need a random number, it launches a routine, which will then operate the pseudo-random generator. This routine consists of consulting the status of the generator and then of performing a computation, which, on the one hand, modifies this status and, on the other hand, returns the desired pseudo-random number. This means that the pseudo-random generator only operates if it is used. More precisely, this means that there has been a relatively small number of random draws actually made since the system was switched on, and the pirate will only have a small number of keys to test to break the system. If this number of keys is a few million or a few billion, it does not take a microcomputer long to test all of them.

A pseudo-random generator is often considerably less expensive to create than a physical generator. If the creation is purely with software, the cost is negligible. Even in case of creation by means of hardware, a low-power coprocessor is sufficient because the algorithms to be used are simple and the storage of the internal status of the generator, i.e., the status bits, occupies very little memory. A pseudo-random generator may be implemented within an integrated circuit on a silicon “chip” and it will then occupy minimal space and will represent a negligible excess cost compared to the cost of designing, developing and manufacturing the integrated circuit.

The present invention described here, which is the subject of the present patent, pertains to a method and a system for making pseudo-random generators secure, thus making it possible to use them by overcoming the various drawbacks described above. It makes it possible to create pseudo-random generators having all the required qualities for applications linked with computer security, among others, with this creation being possible at a significantly lower cost than that of a physical random generator. The present invention may be used for any type of pseudo-random generator, regardless of the mathematical algorithm used, provided that this algorithm is sophisticated enough to prevent the knowledge of the history of draws made from being able to provide any information about the internal status of the generator.

The present invention pertains to a method for making secure a generator generating pseudo-random numbers.

The generator is characterized by an internal status. The generator comprises:
a first storage zone containing status bits, representing the internal status of the generator,
a computing unit performing arithmetic operations on the status bits to produce the pseudo-random numbers and to modify the status bits,
a second storage zone containing the pseudo-random numbers,
a single output making it possible to read the pseudo-random numbers contained in the second storage zone.

The method according to the present invention comprises the step of irreversibly and unconditionally inhibiting, in particular via logical and/or mechanical and/or electronic means, the reading and the writing of the status bits from outside the generator, including via the single output.

Preferably, according to the present invention, the method is more particularly intended for making a generator secure. The generator additionally comprises first computing means comprising an XOR operator and having a single input making it possible to input data coming from an outside source to the generator. The method comprises the step for the first computing means of modifying the status of the status bits by actuating the XOR operator between the data and at least part of the status bits.

The result of the combination of technical features is that the value of the status bits cannot be deduced from the knowledge of the data.

Preferably, according to the present invention, the generator continuously produces pseudo-random numbers for the needs of a computer system and stores the last pseudo-random number produced in the second storage zone replacing the preceding pseudo-random number.

The method comprises the step, for the computer system, of reading the pseudo-random numbers in the second storage zone intermittently, via the single output, in a manner asynchronous in relation to their production.

The result of the combination of technical features is that the random and unpredictable character of the pseudo-random numbers used by the computer system is enhanced.

In the case of another embodiment variant of the present invention, the generator produces pseudo-random numbers for the needs of a computer system. In the case of this embodiment variant, the method additionally comprises an algorithm actuated intermittently by the computer system. The algorithm comprises the following steps:
the step of reading part of the pseudo-random numbers produced by the generator to form a sequence of arguments,
the step of computing a string of interrupt bits by performing arithmetic operations on the arguments,
the step of modifying the status bits by actuating the XOR operator between the string of interrupt bits and at least part of the status bits.

Preferably, in the case of this embodiment variant according to the present invention, the method is such that, to compute the string of interrupt bits:
an encryption key is specified, in particular by means of part of the arguments,
a sequence of numbers to be encrypted is specified, in particular by means of part of the arguments,
an encryption algorithm is actuated to produce the string of interrupt bits by means of the encryption key and the sequence of numbers to be encrypted.

Preferably, the generator itself consists of a plurality of elementary pseudo-random generators, an addressing register and a third storage zone. Each of the elementary pseudo-random generators comprises its own status bits, which are called elementary status bits. The status bits of the generator, contained in the first storage zone of the generator, are formed by the combination of the addressing register, the third storage zone and the elementary status bits.

In the case of this embodiment variant, the method according to the present invention is characterized in that the generation of pseudo-random numbers by the generator comprises the following steps:
the step of retrieving from the addressing register data enabling it to specify, among the elementary pseudo-random generators, which of them shall be used for the next iteration of the process,
the step of operating the elementary pseudo-random generator specified in the preceding step to retrieve therefrom a number hereinafter called the candidate number,
the step of retrieving from part of the bits of the addressing register and from part of the bits of the candidate number data enabling it to specify an address in the third storage zone,
the step of reading in the third storage zone the content of the address specified in the preceding step to provide the pseudo-random numbers,
the step of storing at the address previously specified in the third storage zone part of the bits of the candidate number,
the step of using part of the bits of the candidate number to modify the addressing register.

The present invention pertains to a system for making secure a generator generating pseudo-random numbers. The generator is characterized by an internal status. The generator comprises:
a first storage zone containing status bits, representing the internal status of the generator,
a computing unit performing arithmetic operations on the status bits to produce the pseudo-random numbers and to modify the status bits,
storage means for storing the pseudo-random numbers in a second storage zone,
a single output making it possible to read the pseudo-random numbers contained in the second storage zone.

The system comprises inhibition means for irreversibly and unconditionally inhibiting, in particular via logical and/or mechanical and/or electronic means, the reading and the writing of the status bits from outside the generator, including via the single output.

Preferably, according to the present invention, the generator additionally comprises the first computing means comprising an XOR operator. The first computing means have a single input, making it possible to input the data coming from an outside source to the generator. The first computing means make it possible to modify the status of the status bits by actuating the XOR operator between the data and at least part of the status bits. The result of the combination of technical features is that the value of the status bits cannot be deduced from the knowledge of the data.

Preferably, according to the present invention, the system comprises a computer system. The generator continuously produces pseudo-random numbers for the needs of the computer system.

The storage means store the last pseudo-random number produced in the second storage zone and substitute this last pseudo-random number for the previous pseudo-random number. The computer system comprises reading means connected to the single output for intermittently reading the pseudo-random numbers in the second storage zone, via the single output, in a manner that is asynchronous in relation to their production.

The result of the combination of technical features is that the random and unpredictable character of the pseudo-random numbers used by the computer system is enhanced.

Preferably, in the case of an embodiment variant of the present invention, the system comprises a computer system. The generator produces pseudo-random numbers for the needs of the computer system. The computer system additionally comprises intermittently actuated computer processing means. The computer processing means comprise:
reading means connected to the single output to read part of the pseudo-random numbers and to form a sequence of arguments,
second computing means to compute a string of interrupt bits by performing arithmetic operations on the arguments,
transmission means to transmit the interrupt bits to the first computing means via the single input.

The first computing means make it possible to modify the status bits by actuating an XOR operator between the string of interrupt bits and at least part of the status bits.

Preferably, in the case of this embodiment variant according to the present invention, the second computing means compute the string of interrupt bits:
by specifying an encryption key, in particular by means of part of the arguments,
by specifying a sequence of numbers to be encrypted, in particular by means of part of the arguments,
by actuating encryption means to produce the string of interrupt bits by means of the encryption key and the sequence of numbers to be encrypted.

Preferably, according to an embodiment variant of the present invention, the generator comprises a plurality of elementary pseudo-random generators, an addressing register and a third storage zone. Each of the elementary pseudo-random generators comprises its own status bits, called elementary status bits. The status bits contained in the first storage zone of the generator are formed by the combination of the addressing register, the third storage zone and the elementary status bits.

The generator additionally comprises computer processing means making it possible:
to retrieve from the addressing register data enabling it to specify, among the elementary pseudo-random generators, a particular pseudo-random generator,
to operate a particular pseudo-random generator to provide the candidate number,
to retrieve from part of the bits of the addressing register and from part of the bits of the candidate number data enabling it to specify an address in the third storage zone,
to read in the third storage zone the content of the address, specified in the preceding step, to provide the pseudo-random numbers,
to store at the address previously specified in the third storage zone part of the bits of the candidate number,
to use part of the bits of the candidate number to modify the addressing register.

Thus, the invention described pertains to a pseudo-random generator, which is implemented in such a way that it is impossible to have, from outside, any information about the status bits, i.e., about the internal status of the generator. These status bits are stored in a first storage zone of the generator. Preferably, in a particular embodiment of the present invention, the generator shall use a dedicated processor, using a first storage zone that is only accessible to it alone. In this particular embodiment, the dedicated processor and this first storage zone are physically in a particular hardware device of the silicon integrated circuit type or “chip” of a chip card, and they occupy all or part of this hardware device.

To increase the random character of this generator, it is interrupted at irregular intervals by data, which are called interrupt data and come from an outside source. This interrupt consists of modifying the status bits of the generator, contained in the first storage zone, without knowledge of the interrupt data being able to provide any information about the value of the status bits either before or after the interrupt. An XOR operator applied between at least part of the status bits and the bits of the interrupt data is used to perform this modification. This modification by the XOR operator operates as follows: A bit in the interrupt data, a bit that shall be called the interrupt bit, is consulted for each of the status bits that it is desired to interrupt. If the interrupt bit is 1, the status bit is returned, i.e., 0 is replaced with 1 and 1 with 0. If the interrupt bit is 0, the status bit is not modified. The advantage of such an interrupt is that there is no way, from outside, to know the value of the status bits either before or after the interrupt. More generally, it is always impossible, from outside, to access any information whether or not it pertains to the content of the first storage zone.

The use of a pseudo-random generator using a specific processor has another advantage. We saw above that if the generator only runs based on the needs of the system that uses it, only a small number of random draws will generally have been made from when the system is switched on. Even if this number is on the order of several billion, this makes an easy attack possible if these pseudo-random numbers are used for applications for securing a computer system. One answer is to operate the pseudo-random generator continuously, even if it is not used. Nevertheless, such a solution is not always possible, because it consumes computer resources in the user system, which may be crippling in some cases. If, by contrast, the pseudo-random generator has its own processor, it may run continuously and completely asynchronously in relation to the use of the pseudo-random numbers based on the needs of the user system and without consuming any computer resource of the user system.

In this embodiment, the generator writes the successive pseudo-random numbers in a second storage zone, the newly computed pseudo-random numbers replacing the pseudo-random numbers previously stored in this second storage zone. The computer system using the results of the pseudo-random generator shall read, based on its needs, the numbers stored in this second storage zone. It shall therefore collect the pseudo-random numbers which were just computed. The oldest pseudo-random numbers shall be deleted as new pseudo-random numbers are computed.

Just as an outside source can be used to interrupt the bits of the random generator at irregular intervals, in an embodiment variant of the present invention, the interrupt data can be computed from the pseudo-random numbers themselves, as provided by the generator. To do this, at irregular intervals, and asynchronously in relation to the reading of the numbers by the user system, pseudo-random numbers provided by the pseudo-random generator and stored in the second storage zone shall be read, and then arithmetic operations shall be applied on these pseudo-random numbers in order to provide interrupt data which are intended to interrupt the status bits of the pseudo-random generator.

In a particular embodiment variant, these arithmetic operations shall resort to an encryption algorithm. In this particular embodiment variant, some of the pseudo-random numbers shall make it possible to determine an encryption key, others a number to be encrypted, and the result of this encryption algorithm forms the interrupt bits. Preferably, an encryption algorithm, such as the DES (Data Encryption Standard, as adopted by the American authorities on Nov. 23, 1976), whose statistical properties ensure a random character for the interrupt data thus computed, shall be used.

By way of purely illustrative and nonlimiting example, we describe a particular embodiment of the present invention below.

The present embodiment is based on the pseudo-random generator which had been proposed as a standard by Park and Miller (Communications of the ACM 1988) after having been primarily proposed by Lewis, Goodman and Miller in 1969 and implemented by IBM, among others (e.g., in the APL language) in the 1970s.

In this Park and Miller pseudo-random generator, a “germ” g ranging from 1 to 2\hat{ }31−2 (a\hat{ }b denotes the number a raised to the power b, i.e., the product of b numbers equal to a) is used to compute the pseudo-random number. With each use of the generator (i.e., each time a pseudo-random number is provided), the germ g is multiplied by 7\hat{ }5=16 807, and the modulo remainder, the Mersenne number 2\hat{ }31−1=2 147 483 647 (which is a prime number), is taken from this. The internal status of the Park and Miller generator is defined by the number g, and the status bits are the 31 bits making up this number g.

The Park and Miller pseudo-random generator is sufficient for many applications, but it has some drawbacks that are perfectly crippling.

The first drawback of a Park and Miller pseudo-random generator is that it has a periodicity of about 2 billion (exactly 2\hat{ }31 minus 2). At the end of each cycle of about 2 billion draws, the same values return in the same order. If these values are used to make a computer system secure, this computer system is at the mercy of an attack, called an “attack in force,” consisting of testing all possible values (which is within the capability of any microcomputer). The security of the system is thus equivalent to that which 31-bit keys would provide.

The second drawback of the Park and Miller pseudo-random generator is that this generator is perfectly predictable. The knowledge of the value of the germ at a given moment makes it possible to predict the future values of this germ and thus all the pseudo-random numbers that will be provided by the generator perfectly and with precision.

In the particular embodiment of the present invention presented here by way of example, a plurality of Park and Miller pseudo-random generators operate together. The present invention makes it possible to avoid the usual drawbacks mentioned of the Park and Miller generators as they are classically used. The generator, which is the subject of the present invention, in this particular embodiment, is composed of the following elements, among others:
a 32-bit addressing register,
a third 512-byte storage zone intended for storing random bytes,
a set of 32 Park and Miller pseudo-random generators, called elementary pseudo-random generators below. In terms of hardware, each of these 32 elementary pseudo-random generators has 31 status bits, called elementary status bits. These elementary generators share a single specific coprocessor designed to compute, from a 31-bit number provided as an argument, the modulo remainder 2\hat{ }31−1=2 147 483 647 of the product by 7\hat{ }5=16 807 from this number provided as an argument.

The status bits of the generator, which is the subject of the present invention, are the combination of the elementary status bits of each of the 32 elementary pseudo-random generators (i.e., 32 times 31, and therefore a total of 992 bits), the 32 bits of the addressing register and the 512 bytes of the third storage zone.

The generator, which is the subject of the present invention, provides pseudo-random bytes at regular intervals, each new pseudo-random byte being provided during an iteration which successively performs the following operations: Five particular bits of the addressing register specify which particular Park and Miller pseudo-random generator shall be used among the 32 elementary pseudo-random generators present.

The status of this thus specified particular pseudo-random generator is a 31-bit number, a number which is read and provided as an argument to the specific coprocessor. This coprocessor provides, as a result, a number, called the candidate number, which is the modulo remainder 2\hat{ }31−1=2 147 483 647 of the product of this argument by the number 7\hat{ }5=16 807.

The status of the particular pseudo-random generator specified above then assumes a value equal to that of the candidate number.

Part of the bits of the candidate number and part of the bits of the addressing register are used to compute a 9-bit number which specifies an address in the third storage zone.

The byte of the third storage zone that is found at the address thus specified is the pseudo-random number, a result of the iteration in progress, a number which shall be copied into the second storage zone of the generator, which is the subject of the present invention, this second storage zone being intended for storing the results of the pseudo-random generator.

Eight bits selected from among the 32 bits of the candidate number form a byte which will be called the candidate byte below and which will be written in the third storage zone at the address specified above, i.e., at the place of the byte that had been previously copied into the second storage zone.

The 24 other bits of the candidate number are used to modify the addressing register, this modification consisting, on the one hand, of the application of an XOR operator between some of these bits and some of the bits of the addressing register and, on the other hand, of end-around shifts of the bits of the addressing register.

This ends the iteration in progress, and the generator is ready for the next iteration.

It can be noted that the value of the candidate byte results from the values of a set of 1024 bits, which are, on the one hand, the elementary status bits of each of the 32 elementary pseudo-random generators (i.e., 32 times 31, and therefore a total of 992 bits) and, on the other hand, the 32 bits of the addressing register.

Knowledge of the values of these 1024 bits makes it possible not only to know the candidate byte of the iteration in progress, but also the sequence of the candidate bytes of the next iterations.

The candidate bytes are copied into the third storage zone, and then, from there, they shall subsequently be copied into the second storage zone intended for collecting the pseudo-random bytes that are the final results of the generator, which is the subject of the present invention. The part of the process, consisting of temporarily storing the value of the candidate bytes in the third storage zone before copying them, has the effect of mixing them. The sequence of the final result bytes which will be written in the second storage zone consists of the same bytes as the sequence of candidate bytes, but in a different order. The bytes are therefore swapped before being used. This swapping has the effect that it becomes impossible to again find, from successive pseudo-random numbers provided by the generator, which is the subject of the present invention, or to directly deduce therefrom data concerning the status of the elementary pseudo-random generators or the addressing register. The only way to reconstruct the internal status of the generator, which is the subject of the present invention, or at least the values of the 1024 bits making it possible to reconstruct the sequence of successive candidate bytes, is to proceed by trial and error and to test all the possible values of these bits.

Moreover, the result of the combination of technical features is that the generator, which is the subject of the present invention, in its embodiment variant described above, has a periodicity greater than 2\hat{ }500, if it operates autonomously, without interrupts, which is far beyond current needs and foreseeable needs for the next decades in computer security.

Moreover, if this generator is interrupted in the way described above, it yields quality results comparable to those that a physical random generator based on a purely random phenomenon would yield for applications linked with computer security.

In a particular implementation variant of the embodiment being described, the generator, which is the subject of the present invention, is produced within an integrated circuit comprising other components, including, in particular, a central processor, and these components form the computer system for the needs of which the generator provides pseudo-random numbers. Even the integrated circuit is designed such that it is impossible to obtain any information about the value of the status bits of the generator, which is the subject of the present invention, either from outside the integrated circuit or from the computer system implemented on the integrated circuit and using the pseudo-random numbers provided by the generator. The only communications of the generator with the outside are performed via a single output which enables the computer system to read the numbers contained in the second storage zone and via a single input which makes it possible to interrupt the status bits of the pseudo-random generator by applying the XOR operator between these status bits and the data coming from an outside source to the generator, in such a way that there is no way to have any information about the values of the status bits of the generator.

The generator provides approximately one pseudo-random byte every 100 nanoseconds (i.e., 10 million pseudo-random bytes per second). The pseudo-random bytes are stored in the second storage zone and put at the disposal of the computer system that will draw therefrom according to its needs. A pseudo-random byte that has not been read by this computer system before the next byte is provided shall be deleted and replaced with the next byte. Taking into account the operating speeds of the pseudo-random generator, on the one hand, and of the computer system using these pseudo-random bytes, on the other hand, the latter computer system reads two successive pseudo-random bytes only exceptionally. The pseudo-random bytes are therefore provided in a completely asynchronous manner in relation to the computer system that uses them which increases the random and unpredictable character of those that are actually used.

In this particular embodiment variant of the present invention, the computer system located on the integrated circuit comprises a cryptography block using the DES algorithm (Data Encryption Standard, as adopted by the American authorities on Nov. 23, 1976), hereinafter called the DES block.

At irregular intervals the computer system performs an interrupt operation on the pseudo-random generator, consisting of reading the pseudo-random bytes provided by the generator, using some of them to generate an encryption key and others to generate a string of bytes to be encrypted, using the DES block to encrypt this string of bytes to be encrypted using this encryption key. The result of this encryption is a string of bytes which shall be sent to the pseudo-random generator and which shall be used to modify the status bits of the pseudo-random generator by applying an XOR operator between these status bits and the result of the encryption. This interrupt operation is performed at irregular intervals when the central processor of the computer system is not busy with other tasks. The total time to perform this operation is about a few milliseconds.

We are going to show that the particular embodiment of the present invention described above makes it possible to provide random numbers suitable for applications aimed at making a computer system secure. To quantify the level of resistance of a system to a given type of attack, one defines a notion of entropy linked with the average number of tests that a possible attacker will have to perform before succeeding in penetrating the system with an attack of this type, these tests being performed by taking into account the data that are available to the attacker.

It shall be said that the system has an entropy of n bits to a given type of attack, and that an attacker using this type of attack must perform on average 2\hat{ }n (2 to the power of n) tests in order to penetrate the system. It is considered that an entropy of 128 bits is more than enough to ensure a perfect security to a given type of attack, taking into account the state of the art or foreseeable art in the next decades. In fact, the time needed for all the computers on the planet, if they were used together to carry through this attack to a successful conclusion, is significantly greater than the age of the universe, even taking into account increases in computer performances foreseeable for the next decades.

At the time of switching on the generator, which is the subject of the present invention, in the particular embodiment described here, or at the time of its reinitialization after a power failure, or at the time of a similar type of attack, the status bits representing the internal status of the generator are capable of being found in a known status. The generator performs about 10 million iterations per second. If the number of iterations which separates the initialization or the reinitialization of the generator from the moment at which pseudo-random numbers are used to generate encryption keys is known with perfect precision, and in the absence of any outside interrupt, this encryption key can be determined with precision. Nevertheless, it is believed in practice that there is, based on this number of iterations, an imprecision on the order of the square root of this number. In our example, 6.4 seconds after the reinitialization, the number of iterations is about 2\hat{ }26. If it is assumed that this number is known with a precision on the order of its square root, the pirate will have to perform on average 2\hat{ }13 tests to attack the system successfully, i.e., to find the encryption keys again. The entropy to this type of attack is therefore about 13 bits, which is absolutely insufficient. One year after the switching on, there will have been about 316,000 billion iterations, i.e., about 2\hat{ }48, a number that can be known with a precision of about 2\hat{ }24, i.e., an entropy of 24 bits, which always remains absolutely insufficient.

Now let us consider an interrupt operation that is performed at a random moment, as a function of the activity of the computer system, which is itself linked with outside conditions, such as the load of the system or the traffic on a computer network, and let us imagine that the attacker may know the exact moment of the interrupt with a precision on the order of one ten thousandth of a second. Under these assumptions, there are about 1,000 possible interrupts of this type (i.e., 2\hat{ }10), according to the random numbers used for the interrupt (let us remember that the random numbers located in the second storage zone are modified every ten thousandths of a second). Such an interrupt thus introduces about 10 bits of additional entropy. A dozen of these interrupts is enough to attain an entropy of 128 bits. In the normal operation of the integrated circuit, there may be several tens of interrupts of this type per second. Therefore, the security of the system against this type of attack far exceeds, after a few seconds, anything that might be desired.

The figures will now be described by way of illustrative and nonexhaustive example, in which:

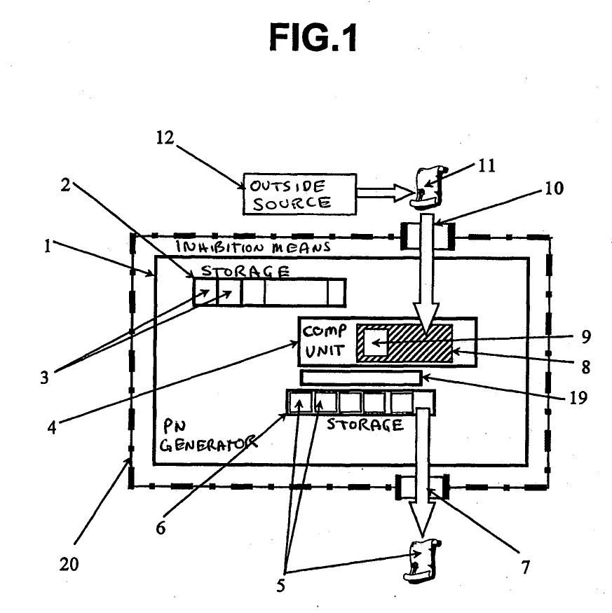

FIG. 1 shows a diagram representing an embodiment variant of the present invention,

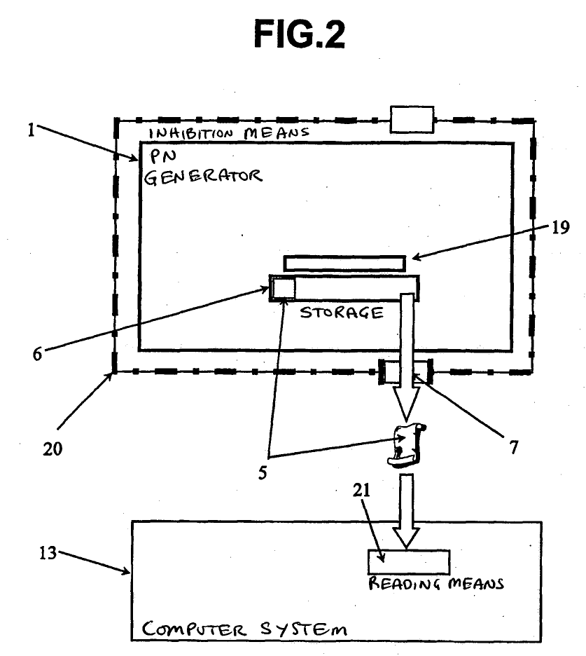

FIG. 2 shows a diagram representing another embodiment variant of the present invention,

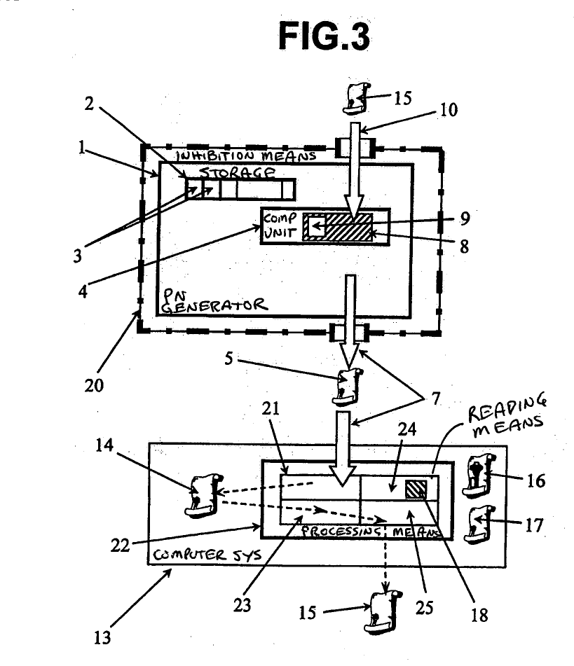

FIG. 3 shows a diagram representing another embodiment variant of the present invention.

FIG. 1 schematically shows the principle of the present invention, which is the subject of the present patent. A pseudo-random generator 1 is composed of a first storage zone 2 intended for storing the internal status of the generator 1, this internal status being represented by the status bits 3. A computing unit 4 performs arithmetic operations on these status bits 3 with a view to modifying these status bits 3, on the one hand, and, on the other hand, to producing pseudo-random numbers 5 which are sent into a second storage zone 6 via storage means 19. These pseudo-random numbers 5 may be read from this second storage zone 6 via a single output 7. The security of the system is a second storage zone 6 via storage means 19. These pseudo-random numbers 5 may be read from this second storage zone 6 via a single output 7. The security of the system is ensured by inhibition means 20 which prevent any operation that would make it possible to obtain, from outside, any information about the value of the status bits 3.

However, these status bits 3 may be modified by means of computing means 8 located in the computing unit 4 and comprising an XOR operator 9. These computing means 8 use data 11 which are provided by an outside source 12 and read via a single input 10. They apply the XOR operator 9 between the data 11 and at least part of the status bits 3 with a view to modifying these status bits 3. Note well that knowledge of the data 11 that are entered during the application of the XOR operator 9 does not provide any information about the value of the status bits 3 either before or after the interrupt.

FIG. 2 schematically shows the manner in which a pseudo-random generator 1, similar to the one in FIG. 1 and protected by its inhibition means 20, can be used with a view to providing random numbers 5 to a computer system 13. This computer system 13 comprises reading means 21 making it possible to read these random numbers 5 in the second storage zone 6 of the generator 1 via the single output 7, as they had been stored by the storage means 19. The random numbers 5 are read based on the needs of the computer system 13, in a manner asynchronous to their production, thus enhancing the random and unpredictable character of the random numbers provided. As new random numbers 5 are generated by the generator 1, they are stored in the second storage zone 6 by the storage means 19, the most recently produced random number replacing the previous random number, the latter being definitively forgotten.

FIG. 3 schematically shows the manner in which a pseudo-random generator 1, similar to that in FIGS. 1 and 2 and protected by its inhibition means 20, producing random numbers 5 for the needs of a computer system 13, can be intermittently interrupted in order to increase the random and unpredictable character of the pseudo-random numbers 5 thus produced. The computer system 13 comprises computer processing means 22. These computer processing means 22 comprise reading means 21 which read the random numbers 5 provided by the pseudo-random generator 1 via the output 7, and use them to form a sequence of arguments 14. The computer processing means 22 also comprise second computing means 23 making it possible to compute, from the arguments 14, a string of interrupt bits 15, which are transmitted via the transmission means 25 to the single input 10 of the pseudo-random generator 1. This single input 10 transmits them to the first computing means 8 located in the computing unit 4 of the pseudo-random generator 1. These computing means 8 use these interrupt bits 15 to modify the status of the generator by applying the XOR operator 9 between the interrupt bits 15 and at least part of the status bits 3 located in the first storage zone 2.

In a particular embodiment, the interrupt bits 15 are computed from the sequence of arguments 14 by means of encryption means 24, being part of the computer processing means 22 and actuating an encryption algorithm 18 using, on the one hand, an encryption key 16 and, on the other hand, numbers to be encrypted 17, this encryption key 16 and these numbers to be encrypted 17 being specified from at least part of the arguments 14.

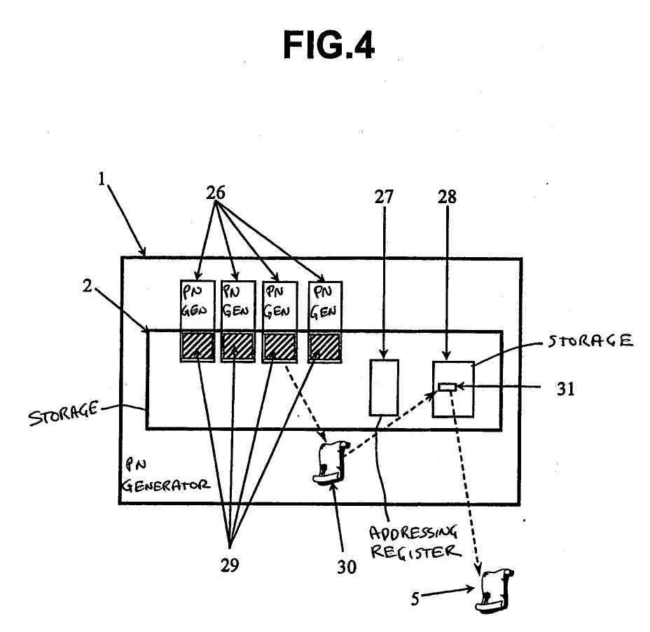

FIG. 4 schematically shows a particular embodiment variant of the present invention, in which the pseudo-random generator 1 is itself composed of a plurality of elementary pseudo-random generators 26, an addressing register 27 and a third storage zone 28. Each of the elementary pseudo-random generators 26 comprises its own status bits called elementary status bits 29. The status bits of the generator 1 are contained in the first storage zone 2 and are formed by the combination of the addressing register 27, the third storage zone 28 and the elementary status bits 29. The addressing register 27 contains, on the one hand, data making it possible to specify, among the elementary pseudo-random generator 26, which of them will be used to provide a candidate number 30, and, on the other hand, data making it possible to specify an address 31 in the third storage zone 2. It is at this address 31 that the next pseudo-random number 5 provided by the pseudo-random generator 1 is read. After this number 5 is read, part of the bits of the candidate number 30 shall be stored at this address 31. Moreover, part of the bits of the candidate number 30 are used to modify the addressing register 27.

1. Method for making secure a generator generating said pseudo-random numbers; the generator being characterized by an internal status;
the generator comprising:
a first storage zones containing the status bits, representing the internal status of the generator,
a computing unit performing arithmetic operations on said status bits to produce the pseudo-random numbers and to modify the status bits,
a second storage zone containing the pseudo-random numbers,
a single output for reading the pseudo-random numbers contained in the second storage zone,
the method comprising the step of irreversibly and unconditionally inhibiting, via at least by one of logical or mechanical or electronic means, the reading and the writing of the status bits from outside the generator, including via the single output.

2. Method in accordance with claim 1; the method being for securing the generator and additionally comprising first computing means comprising a XOR operator and having a single input for inputting data coming from a outside source to the generator;
the method comprising the step, for the first computing means, of modifying the status of the status bits by actuating the XOR operator between the data and at least some of the status bits.

3. Method in accordance with any of the claims 1 or 2; the generator continuously producing the pseudo-random numbers for a computer system and storing the last pseudo-random number produced in the second storage zone by replacing a previously produced pseudo-random number;
the method comprising the step, for the computer system, of intermittently reading in the second storage zone, via the single output, the pseudo-random numbers in a manner asynchronous in relation to their production.

4. Method in accordance with claim 2; the generator producing said pseudo-random numbers for a computer system; the method additionally comprising an algorithm intermittently actuated by the computer system; the algorithm comprising the following steps:
the step of reading part of the pseudo-random numbers produced by the generator to form a sequence of said arguments,
the step of computing a string of interrupt bits by performing arithmetic operations on the arguments,
the step of modifying the status bits by actuating the XOR operator between the string of interrupt bits and at least some of the status bits.

5. Method in accordance with claim 4; the method being such that to compute the string of interrupt bits:
a encryption key is specified, in particular by means of part of the arguments,
a sequence of said numbers to be encrypted is specified, in particular by means of part of the arguments,
a encryption algorithm is actuated to produce the string of interrupt bits by means of the encryption key and the sequence of numbers to be encrypted.

6. Method in accordance with any of the claims 1, 2, 4 or 5; the generator itself consisting of a plurality of said elementary pseudo-random generators, a addressing register and a third storage zone, each of the elementary pseudo-random generators comprising respective elementary status bits, the status bits contained in the first storage zone of the generator being formed by the combination of the addressing register, the third storage zone and the elementary status bits,
the method being characterized in that the generation of the pseudo-random numbers by the generator comprises the following steps:
the step of retrieving from the addressing register data enabling it to specify, among the elementary pseudo-random generators, which of them shall be used for the next iteration of the process,
the step of operating the elementary pseudo-random generator specified in the preceding step to retrieve therefrom a number hereinafter called the candidate number,
the step of retrieving from part of the bits of the addressing register and from part of the bits of the candidate number data enabling it to specify a address in the third storage zoned,
the step of reading in the third storage zone the content of the address specified in the retrieving step to provide the pseudo-random numbers,
the step of storing at the address previously specified in the third storage zone part of the bits of the candidate number,
the step of using part of the bits of the candidate numbers to modify the addressing register.

7. System for making secure a generator generating said pseudo-random numbers; the generator being characterized by an internal status; the generator comprising:
a first storage zone containing said status bits, representing the internal status of the generator,
a computing unit performing arithmetic operations on the status bits to produce the pseudo-random numbers and to modify the status bits,
said storage means to store the pseudo-random numbers in a second storage zone,
a single output making it possible to read the pseudo-random numbers contained in the second storage zone,
the system comprising inhibition means for irreversibly and unconditionally inhibiting, by at least one of logical or mechanical or electronic means, the reading and the writing of the status bits from outside the generator, including via the single output.

8. System in accordance with claim 7; the generator additionally comprising said first computing means comprising a XOR operator; the first computing means having a single input making it possible to input said data coming from an outside source to the generator; the first computing means configured to modify the status of the status bits by actuating the XOR operator between the data and at least some of the status bits.

9. System in accordance with any of the claims 7 or 8; the system comprising a computer system; the generator continuously producing said pseudo-random numbers for a computer systems; the storage means storing the last pseudo-random number produced in the second storage zone and the last pseudo-random number replacing a previously produced pseudo-random number;
the computer system comprising reading means connected to the single output to intermittently read in the second storage zone, via the single output, the pseudo-random numbers in a manner asynchronous in relation to their production.

10. System in accordance with claim 8; the system comprising a computer system; the generator producing said pseudo-random numbers for a computer system; the computer system additionally comprising said intermittently actuated computer processing means; the computer processing means comprising:
said reading means connected to the single output for reading part of the pseudo-random numbers and for forming a sequence of said arguments,
second computing means for computing a string of said interrupt bits by performing arithmetic operations on the arguments,
transmission means for transmitting the interrupt bits to the first computing means via the single input;
the first computing means configured to modify the status bits by actuating the XOR operator between the string of interrupt bits and at least some of the status bits.

11. System in accordance with claim 10; the second computing means computing the string of interrupt bits:
by specifying an encryption key,
by specifying a sequence of said numbers to be encrypted,
by actuating the encryption means to produce the string of interrupt bits by means of said encryption key and the sequence of numbers to be encrypted.

12. System in accordance with any of the claims 7, 8, 10 or 11; the generator comprising a plurality of elementary pseudo-random generators, an addressing register and a third storage zone, each of the elementary pseudo-random generator comprising respective elementary status bits, the status bits contained in the first storage zone of the generator being formed by the combination of the addressing register, the third storage zone and the elementary status bits,
the generators additionally comprising computer processing means:
to retrieve from the addressing register data, for specifying from among the elementary pseudo-random generators, a particular pseudo-random generator,
to operate the particular pseudo-random generator to provide the candidate number,
to retrieve from part of the bits of the addressing register and from part of the bits of the candidate number, data to specify an address in the third storage zone,
to read from the third storage zone an address to provide the pseudo-random numbers,
to store at the address in the third storage zone some of the bits of the candidate number,
to use some of the bits of the candidate number to modify the addressing register.
